(19) United States
(12) Patent Application Publication
(10) Pub. No.: US 2013/0118286 A1
(43) Pub. Date: May 16, 2013

(54) ROBOT ARM ASSEMBLY

(71) Applicant: Bo LONG, Shenzhen City (CN)

(72) Inventor: Bo LONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/550,686

(22) Filed: Jul. 17, 2012

(30) Foreign Application Priority Data
Nov. 10, 2011 (CN) 201110354581.5

(51) Int. Cl. B25J 18/00

(52) U.S. Cl. 74/490.01; 901/26

(57) ABSTRACT

A robot arm assembly includes a first mechanical arm, a second mechanical arm, a third mechanical arm, a first transmission assembly and a second transmission assembly. The first mechanical arm, the second mechanical arm and the third mechanical arm are rotatably connected together in that order, and are respectively configured to rotate along a first axis A, a second axis B and a third axis C. The first transmission assembly is assembled within the first mechanical arm and the second mechanical arm, and is further coupled with the third mechanical arm. The second transmission assembly is assembled within the first mechanical arm and sleeved on the first transmission assembly, the second transmission assembly is further coupled with the second mechanical arm.

### BACKGROUND

1. Technical Field

The present disclosure relates to an industrial robot, and more particularly, to a robot arm assembly of the industrial robot.

2. Description of Related Art

A commonly used industrial robot includes a plurality of arms rotatably connected to each other in order, thus, a movement of multiple axis is achieved. For example, a driving member is assembled between the first mechanical arm and the second mechanical arm to drive the second mechanical arm to rotate with respect to the first mechanical arm. Therefore, a number of driving members should be assembled between arms if the manipulator has many arms. Thus, the driving members are scattered between the arms of robot arm assembly. This result is the robot arm assembly is more complicated and space consuming.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 shows an isometric view of an embodiment of a robot arm assembly.

FIG. 2 shows an exploded, isometric view of the robot arm assembly of FIG. 1.

FIG. 3 shows a cross-sectional view of the robot arm assembly of FIG. 1, taken along line III-III.

### DETAILED DESCRIPTION

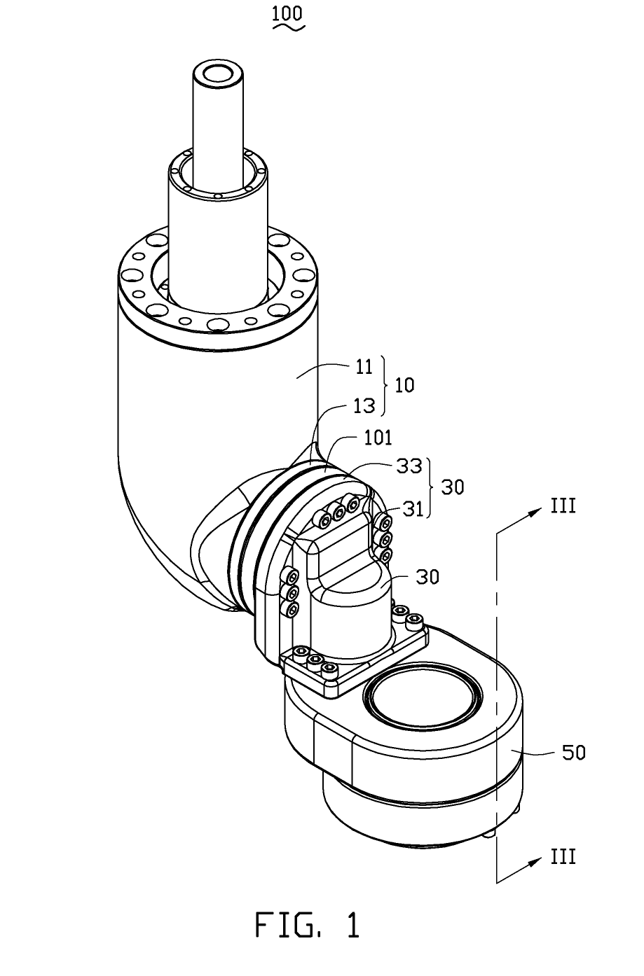

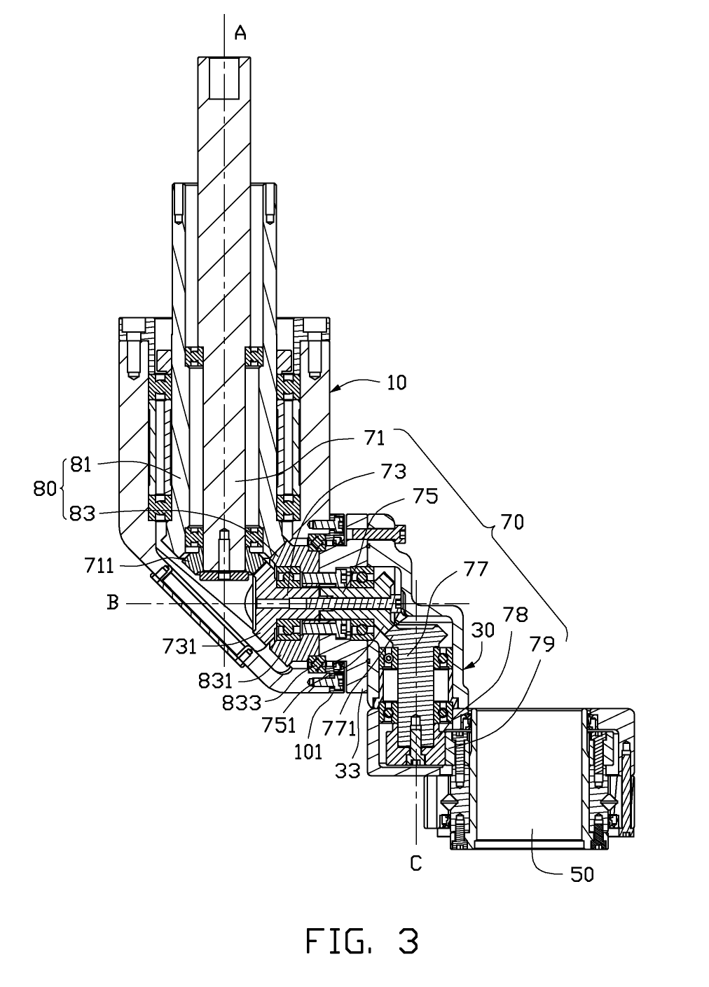

FIGS. 1 and 3, illustrate an embodiment of a robot arm assembly 100 used in six-axis industrial robot. The robot arm assembly 100 includes a first mechanical arm 10, a second mechanical arm 30, a third mechanical arm 50, a first transmission assembly 70, and a second transmission assembly 80. The first mechanical arm 10, the second mechanical arm 30, and the third mechanical arm 50 are rotatably connected together in that order, such that, the second mechanical arm 30 is assembled between the first mechanical arm 10 and the third mechanical arm 50. The third mechanical arm 50 is configured for mounting a tool (not shown) such as a fixture, a gripper, a cutting tool, for example. The first mechanical arm 10, the second mechanical arm 30 and the third mechanical arm 50 are respectively configured to rotate along a first axis A, a second axis B and a third axis C of the six-axis robot. In the embodiment, the first axis A and the third axis C are substantially parallel, and substantially perpendicular to the second axis B. The first transmission assembly 70 is movably assembled within the first mechanical arm 10 and the second mechanical arm 30, and is further coupled with the third mechanical arm 50. The second transmission assembly 80 is movably assembled within the first mechanical arm 10 and is further coupled with the second mechanical arm 30.

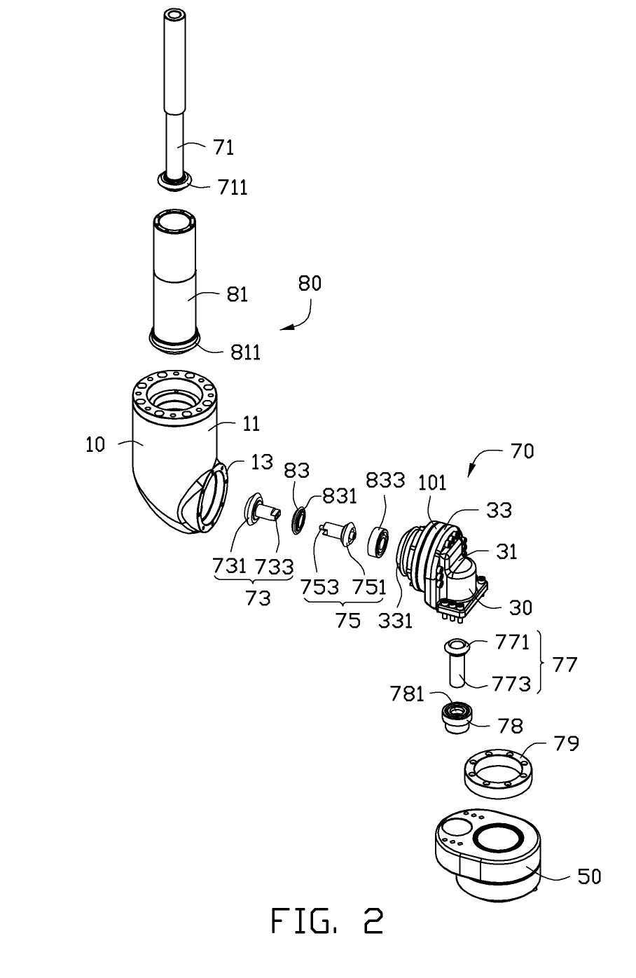

Also referring to FIG. 2, the first mechanical arm 10 and the second mechanical arm 30 are both substantially L-shaped hollow tube structures and cooperatively form a hollow stepped shaft. The first transmission assembly 70 and the second transmission assembly 80 are received inside of the hollow stepped shaft. In the illustrated embodiment, the first mechanical arm 10 includes a main arm portion 11 and a connecting end 13 extending and bending from one end of the main arm portion 11. A substantially hollow ring shaped connecting base 101 is mounted to the connecting end 13 of the first mechanical arm 10. The second mechanical arm 30 includes a base arm portion 31 and a mounting end 33 extending and bending from a first end of the base arm portion 31. A shoulder 331 is formed on the mounting end 33 corresponding to the connecting base 101 of the first mechanical arm 10. In assembly, the connecting base 101 is movably sleeved on the shoulder 331 of the second mechanical arm 30, thereby rotatably connecting the connecting end 13 of the first mechanical arm 10 and the mounting end 33 of the second mechanical arm 30 together. The main arm portion 11 of the first mechanical arm 10 and the base arm portion 31 of the second mechanical arm 30 are substantially parallel to each other and respectively perpendicular to the connecting end 13 of the first mechanical arm 10 and the mounting end 33 of the second mechanical arm 30.

The third mechanical arm 50 is substantially hollow cylindrical, and is assembled with a second end of the base arm portion 31 of the second mechanical arm 30. A distal end of the third mechanical arm 50 away from the second mechanical arm 30, forms a flange (not labeled) for mounting the tool.

The first transmission assembly 70 is movably assembled within the first mechanical arm 10 and the second mechanical arm 30, and is further coupled with the third mechanical arm 50. The first transmission assembly 70 includes a first rotation shaft 71, a second rotation shaft 73, a third rotation shaft 75, a fourth rotation shaft 77, a first gear 78, and a second gear 79. The first rotation shaft 71, the second rotation shaft 73 and the third rotation shaft 75 are all hollow structures. The first rotation shaft 71 is assembled within the main arm portion 11 of the first mechanical arm 10, and forms a first bevel gear portion 711 at a first end of the first rotation shaft 71, facing toward the connecting end 13. A second end of the first rotation shaft 71 is exposed form a distal end of the main arm portion 11 away from the connecting end 13.

The second rotation shaft 73 is assembled within the connecting end 13 of the first mechanical arm 10 and rotatably engages with the first rotation shaft 71. A first end of the second rotation shaft 73 forms a second bevel gear portion 731 corresponding to the first bevel gear portion 711 of the first rotation shaft 71. An opposite second end of the second rotation shaft 73 defines a latching slot 733. The second rotation shaft 73 is perpendicular to the first rotation shaft 71, the second bevel gear portion 731 meshes with the corresponding first bevel gear portion 711 of the first rotation shaft 71.

The third rotation shaft 75 is assembled within the mounting end 33 of the second mechanical arm 30 and is non-rotatably connected with the second rotation shaft 73. A first end of the third rotation shaft 75 forms a latching protrusion 753 corresponding to the latching slot 733 of the second rotation shaft 73, and an opposite second end of the third rotation shaft 75 forms a third bevel gear portion 751. The latching protrusion 753 of the third rotation shaft 75 latches into the corresponding latching slot 733 of the second rotation shaft 73 thereby non-rotatably connecting the second rotation shaft 73 and the third rotation shaft 75 together.

The fourth rotation shaft 77 is assembled within the base arm portion 31 of the second mechanical arm 30 and further rotatably assembled with the third rotation shaft 75. A first end of the fourth rotation shaft 77 forms a fourth bevel gear portion 771 corresponding to the third bevel gear portion 751 of the third rotation shaft 75, and an opposite second end of the fourth rotation shaft 77 forms a mounting portion 773. The fourth rotation shaft 77 is perpendicular to the third rotation shaft 75, the fourth bevel gear portion 771 of the fourth rotation shaft 77 meshes with the corresponding third bevel gear portion 751 of the third rotation shaft 75.

The first gear 78 is securely assembled to the mounting portion 773 of the fourth rotation shaft 77 and is received within the base arm portion 31 of the second mechanical arm 30. The first gear 78 defines mounting hole 781 corresponding to the mounting portion 773 of the fourth rotation shaft 77. The second gear 79 is securely assembled within the third mechanical arm 50 and further rotatably meshes and engages with the corresponding first gear 78.

The second transmission assembly 80 is movably assembled within the first mechanical arm 10 and is further coupled with the second mechanical arm 30. The second transmission assembly 80 includes a transmitting shaft 81 and a bevel gear shaft 83. The transmitting shaft 81 and the bevel gear shaft 83 are both hollow structures. The transmitting shaft 81 is assembled within the main arm portion 11 of the first mechanical arm 10, and further movably sleeved on the first rotation shaft 71. A first end of the transmitting shaft 81 forms a bevel gear portion 811 facing toward the connecting end 13. An opposite second end of the transmitting shaft 81 is exposed from the main arm portion 11, away from the connecting end 13. The bevel gear shaft 83 is assembled within the connecting end 13 of the first mechanical arm 10, and is coaxially sleeved on the second rotation shaft 73. The bevel gear shaft 83 forms a bevel gear portion 831 corresponding to the bevel gear portion 811 of the transmitting shaft 81. The bevel gear portion 831 meshes with the corresponding bevel gear portion 811. The bevel gear shaft 83 is further fixed with the mounting end 33 of the second mechanical arm 30 and is supported by a cross roller bearing 833 which is sleeved on a conjunction of the bevel gear shaft 83 and the mounting end 33.

In use, the first mechanical arm 10, the first rotation shaft 71 and the transmitting shaft 81 are respectively driven to rotate by a driving mechanism (not shown). When the first mechanical arm 10 is driven to rotate under the driving mechanism along the first axis A, the second mechanical arm 30 and the third mechanical arm 50 are both driven to rotate along the first axis A, together with the first mechanical arm 10. When the first rotation shaft 71 is driven to rotate along the first axis A, the second rotation shaft 73 is driven to rotate along the second axis B, together with the third rotation shaft 75, meanwhile, the fourth rotation shaft 77 is driven to rotate along the third axis C, together with the first gear 78 and the second gear 79. Since the second gear 79 is fixed with the third mechanical arm 50, thus, the third mechanical arm 50 is driven to rotate along the third axis C and is also capable of being driven to rotate about 360 degrees. When the transmitting shaft 81 is driven to rotate by the driving mechanism, along the first axis A, the bevel gear shaft 83 is driven to rotate along the second axis B simultaneously. Since the bevel gear shaft 83 is fixed with the second mechanical arm 30, thus, the second mechanical arm 30 and the third mechanical arm 50 together with the bevel gear shat 83 is capable of being driven to rotate along the second axis B about 360 degrees.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A robot arm assembly comprising:
a first mechanical arm;
a second mechanical arm rotatably assembled with the first mechanical arm;
a third mechanical arm rotatably assembled with the second mechanical arm;
a first transmission assembly assembled within the first mechanical arm and the second mechanical arm, and further coupled with the third mechanical arm; and
a second transmission assembly assembled within the first mechanical arm and sleeved on the first transmission assembly, the second transmission assembly further coupled with the second mechanical arm;
wherein, the first mechanical arm, the second mechanical arm and the third mechanical arm are capable of being respectively driven to rotate along a first axis A, a second axis B and a third axis C.

2. The robot arm assembly of claim 1, wherein the first mechanical arm comprises a main arm portion and a connecting end extending and bending from one end of the main arm portion; the second mechanical arm comprises a base arm portion and a mounting end extending and bending from a first end of the base arm portion; the connecting end of the first mechanical arm is rotatably assembled with the mounting end of the second mechanical arm; the main arm portion of the first mechanical arm and the base arm portion of the second mechanical arm are substantially parallel to each other and respectively perpendicular to the connecting end of the first mechanical arm and the mounting end of the second mechanical arm.

3. The robot arm assembly of claim 2, wherein the third mechanical arm is substantially hollow cylindrical, and is assembled with a second end of the base arm portion of the second mechanical arm; and a distal end of the third mechanical arm away from the second mechanical arm forms a flange for mounting a tool.

4. The robot arm assembly of claim 3, wherein the first transmission assembly comprises a first rotation shaft, a second rotation shaft, and a third rotation shaft, the first rotation shaft is assembled within the main arm portion of the first mechanical arm, and forms a first bevel gear portion at a first end of the first rotation shaft, facing toward the connecting end; the second rotation shaft is assembled within the connecting end of the first mechanical arm and forms a second bevel gear portion at a first end thereof to rotatably mesh with the corresponding first bevel gear portion of the first rotation shaft; the third rotation shaft is assembled within the mounting end of the second mechanical arm and is non-rotatably connected with the second rotation shaft.

5. The robot arm assembly of claim 4, wherein the second transmission assembly comprises a hollow transmitting shaft and a hollow bevel gear shaft, the transmitting shaft is assembled within the main arm portion of the first mechanical arm, and further movably sleeved on the first rotation shaft; a first end of the transmitting shaft forms a bevel gear portion, the bevel gear shaft is assembled within the connecting end of the first mechanical arm, and is coaxially sleeved on the second rotation shaft; the bevel gear shaft forms a bevel gear portion meshing with the corresponding bevel gear portion of the transmitting shaft; the bevel gear shaft is fixed with the mounting end of the second mechanical arm.

6. The robot arm assembly of claim 5, further comprising a cross roller bearing sleeved on a conjunction of the bevel gear shaft and the mounting end for supporting the bevel gear shaft.

7. The robot arm assembly of claim 4, wherein the first transmission assembly further comprises a fourth rotation shaft assembled within the base arm portion of the second mechanical arm and further rotatably assembled with the third rotation shaft; a first end of the fourth rotation shaft forms a fourth bevel gear portion meshing with the corresponding third bevel gear portion, an opposite second end of the fourth rotation shaft forms a mounting portion.

8. The robot arm assembly of claim 7, wherein the first transmission assembly further comprises a first gear and a second gear, the first gear is fixedly assembled to the mounting portion of the fourth rotation shaft and is received within the base arm portion; the first gear defines mounting hole engaging with the corresponding mounting portion of the fourth rotation shaft; the second gear is fixedly assembled within the third mechanical arm and further rotatably meshes and engages with the corresponding first gear.

9. The robot arm assembly of claim 1, wherein the first axis A and the third axis C are substantially parallel, and substantially perpendicular to the second axis B.

10. The robot arm assembly of claim 2, wherein the first mechanical arm and the second mechanical arm are both substantially L-shaped hollow tube structures and cooperatively form a hollow stepped shaft, the first transmission assembly and the second transmission assembly are received inside of the hollow stepped shaft.

11. A robot arm assembly comprising:
a first mechanical arm;
a second mechanical arm;
a third mechanical arm; wherein, the first mechanical arm, the second mechanical arm and the third mechanical arm are rotatably connected together in that order, and are respectively configured to rotate along a first axis A, a second axis B and a third axis C;
a first transmission assembly assembled within the first mechanical arm and the second mechanical arm, and further coupled with the third mechanical arm; and
a second transmission assembly assembled within the first mechanical arm and sleeved on the first transmission assembly, the second transmission assembly further coupled with the second mechanical arm;
wherein, the first transmission assembly comprises a first rotation shaft, a second rotation shaft, and a third rotation shaft, the first rotation shaft forms a first bevel gear portion, the second rotation shaft forms a second bevel gear portion to rotatably mesh with the corresponding first bevel gear portion of the first rotation shaft; the third rotation shaft is assembled within the second mechanical arm and is non-rotatably connected with the second rotation shaft; the second transmission assembly comprises a hollow transmitting shaft and a hollow bevel gear shaft, the transmitting shaft is assembled within the first mechanical arm and movably sleeved on the first rotation shaft; a first end of the transmitting shaft forms a bevel gear portion, the bevel gear shaft is assembled within the first mechanical arm and coaxially sleeved on the second rotation shaft; the bevel gear shaft forms a bevel gear portion meshing with the corresponding bevel gear portion of the transmitting shaft; the bevel gear shaft is fixed with the mounting end of the second mechanical arm.

12. The robot arm assembly of claim 11, wherein the first mechanical arm and the second mechanical arm are both substantially L-shaped hollow tube structures and cooperatively form a hollow stepped shaft, the first transmission assembly and the second transmission assembly are received inside of the hollow stepped shaft.

13. The robot arm assembly of claim 12, wherein the first mechanical arm comprises a main arm portion and a connecting end extending from one end of the main arm portion, the second mechanical arm comprises a base arm portion and a mounting end extending from a first end of the base arm portion; the connecting end of the first mechanical arm is rotatably assembled with the mounting end of the second mechanical arm; the main arm portion of the first mechanical arm and the base arm portion of the second mechanical arm are substantially parallel to each other and respectively perpendicular to the connecting end of the first mechanical arm and the mounting end of the second mechanical arm; the third mechanical arm is assembled to a second end of the base arm portion, the first rotation shaft and the second rotation shaft are respectively assembled within the main arm portion and the connecting end of the first mechanical arm, the third rotation shaft is assembled within the mounting end of the second mechanical arm.

14. The robot arm assembly of claim 13, wherein the first transmission assembly further comprises a fourth rotation shaft assembled within the base arm portion of the second mechanical arm and further rotatably assembled with the third rotation shaft; a first end of the fourth rotation shaft forms a fourth bevel gear portion meshing with the corresponding third bevel gear portion, an opposite second end of the fourth rotation shaft forms a mounting portion.

15. The robot arm assembly of claim 13, wherein the first transmission assembly further comprises a first gear and a second gear, the first gear is fixedly assembled to the mounting portion of the fourth rotation shaft and is received within the base arm portion; the first gear defines mounting hole engaging with the corresponding mounting portion of the fourth rotation shaft; the second gear is fixedly assembled within the third mechanical arm and further rotatably meshes and engages with the corresponding first gear.

16. The robot arm assembly of claim 13, wherein further comprising a cross roller bearing sleeved on a conjunction of the bevel gear shaft and the mounting end for supporting the bevel gear shaft.
